(19) United States
(12) Patent Application Publication
(10) Pub. No.: US 2022/0324390 A1
(43) Pub. Date: Oct. 13, 2022

(54) VEHICLE RACK SYSTEM

(71) Applicant: Inneva Group Limited, Derby (GB)

(72) Inventor: Michael Roy Hudswell, Derby (GB)

(21) Appl. No.: 17/606,703

(22) PCT Filed: Oct. 29, 2020
(86) PCT No.: PCT/GB2020/051032

§ 371 Date: Oct. 26, 2021

(30) Foreign Application Priority Data
Apr. 26, 2019 (GB) 1905883.3

(51) Int. Cl. B60R 9/042

(52) U.S. Cl. CPC B60R 9/0423

(57) ABSTRACT

There is disclosed a vehicle rack system (2) for mounting atop a roof of a vehicle. The rack system has a support member (4) affixed to the vehicle in use and a carriage (8) for supporting a load. The carriage (8) is attached to the support member such that the carriage (8) is both translatable and rotatable relative to the support member (4) between a storage position and a deployed position. The support member has a rotatable engagement member (10) to engage and support the carriage (8) during translation and rotation between the storage position and the deployed position, where one of the carriage (8) and the engagement member (10) comprises a plurality of spaced protrusions and the other of the carriage and the engagement member comprises a series of recesses at corresponding spacing arranged to receive the protrusions. A rack and pinion system may be used. An axle is used for driving rotation of the engagement member (10) to cause the carriage to move over the engagement member in unison therewith.

The present invention relates to a vehicle rack system, particularly for a vehicle rack system for transporting ladders or other equipment atop a vehicle.

When transporting a ladder on a vehicle, it is conventional to store the ladder on a rack installed on the roof. However, such racks are often difficult to access due to the height of the vehicle (for example, when installed on van). This increases difficulty in raising or lowering the ladder onto/from the rack, and the difficulty in unsecuring/securing the ladder to rack. Furthermore, this may pose a health and safety risk, for example, from falling from the vehicle, or a risk of injury due to over stretching or lifting the heavy ladder. It is generally undesirable for a user to be repeatedly raising/lowering significant weight above shoulder height.

In a first prior art solution, the ladder is mounted to a carriage slidably attached to a roof mounted rack. The operator slides the carriage towards the rear of the vehicle to extend over a back end thereof, at which point, the carriage can pivot downwards, so that the ladder is in a substantially vertical position.

However, once the ladder is detached from the carriage, the carriage is positioned in front of the back door, thereby preventing access. Therefore, the carriage must be moved upwards back on the rack, to enable access. A further problem is that the carriage is freely pivotable, so as the carriage and ladder pivot over the back end of the vehicle, the weight of the carriage and the ladder must be supported by the operator. This therefore does little to mitigate the risk of injury due to the weight of the ladder and carriage and/or the repetitive lifting thereof.

In a second prior art solution, the ladder is mounted to a carriage rotatably attached to a roof mounted rack via a four bar linkage. The operator may rotate the carriage downwards such that the carriage rotates over the side of the vehicle. However, the four bar linkage requires that the carriage first increases in height as it is rotated, before it drops down the side of the vehicle. This motion requires a relatively large initial force to displace the ladder from atop the vehicle and increases the speed at which the carriage and ladder drop down, i.e. under the full weight of the ladder, creating a significant jolt/force as the carriage reaches the extended position. This may cause injury to a user, damage the vehicle side and/or may put additional stress/strain on the system, e.g. reducing the operating lifetime thereof.

This may be mitigated by providing one or more gas springs to bias the carriage back toward the rack. This reduces the effective weight of the carriage and ladder when rotating the carriage downwards, thereby reducing the weight burden on the operator.

However the gas springs must be tuned to provide an appropriate biasing force. A high biasing force will reduce the weight burden on the operator, however the gas springs are acting to rotate the carriage back toward the rack. This also poses difficulties when loading the carriage, as the carriage must be held down against the biasing force of the gas springs whilst attaching the ladder. Alternatively, a low biasing force will increase the weight burden on the user and lessens the benefit of the system. The gas springs must be optimised for a given load on the carriage and must be designed to supported a predetermined number of ladders (e.g. one ladder, two ladders etc). Such a system is inflexible and can only use used safely for the predetermined number of ladders. For example, if a two-ladder system is only loaded with one ladder, the gas springs have been found to pull the ladder up atop the vehicle unintentionally.

It is an objective of the present invention to provide an improved and/or alternative system, which may overcome one or more of the above problems.

According to the present invention, there is provided a vehicle rack system comprising: a support member affixed to a vehicle in use; a carriage, for supporting a load, attached to the support member, the carriage both translatable and rotatable relative to the support member between a storage position and a deployed position; and the support member comprising a rotatable engagement member to engage and support the carriage during translation and rotation between the retracted state and the extended state.

Further preferable features are defined in the appended claims.

Practicable embodiments of the invention are described below in further detail with reference to the figures, of which:

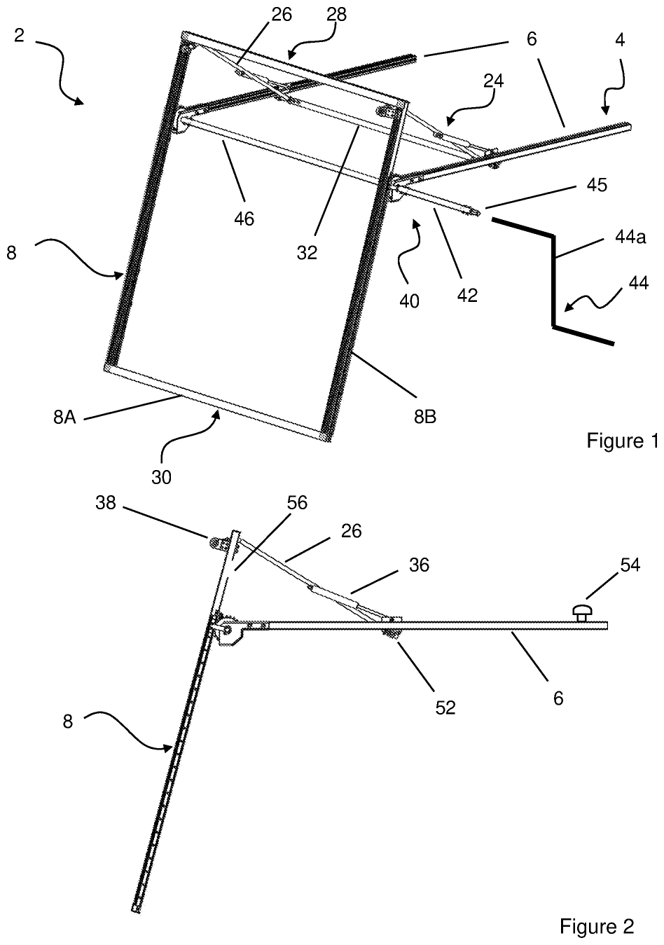

FIG. 1 shows an isometric view of a rack system in a deployed position.

FIG. 2 shows a side view of a rack system in a deployed position.

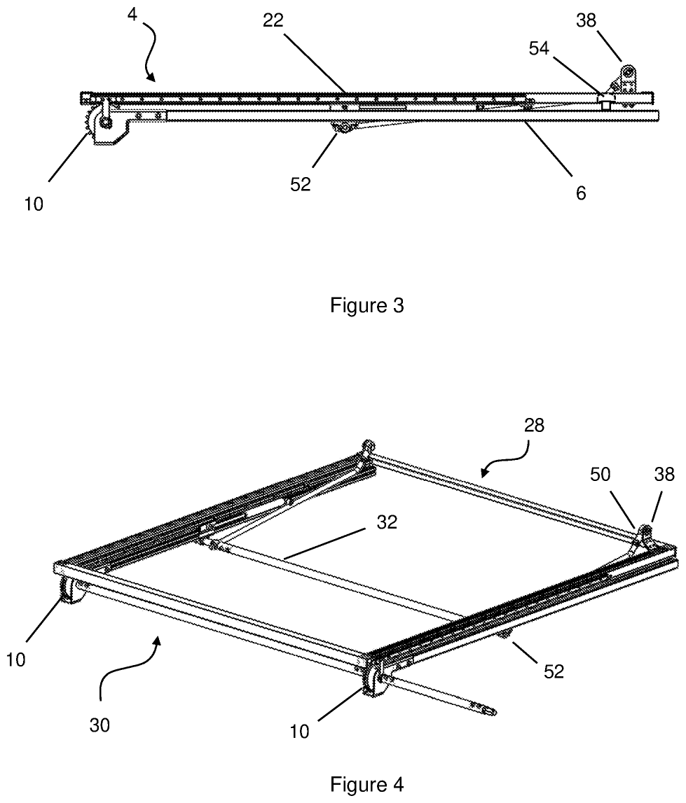

FIG. 3 shows a side view of a rack system in a storage position.

FIG. 4 shows an isometric view of a rack system in a storage position.

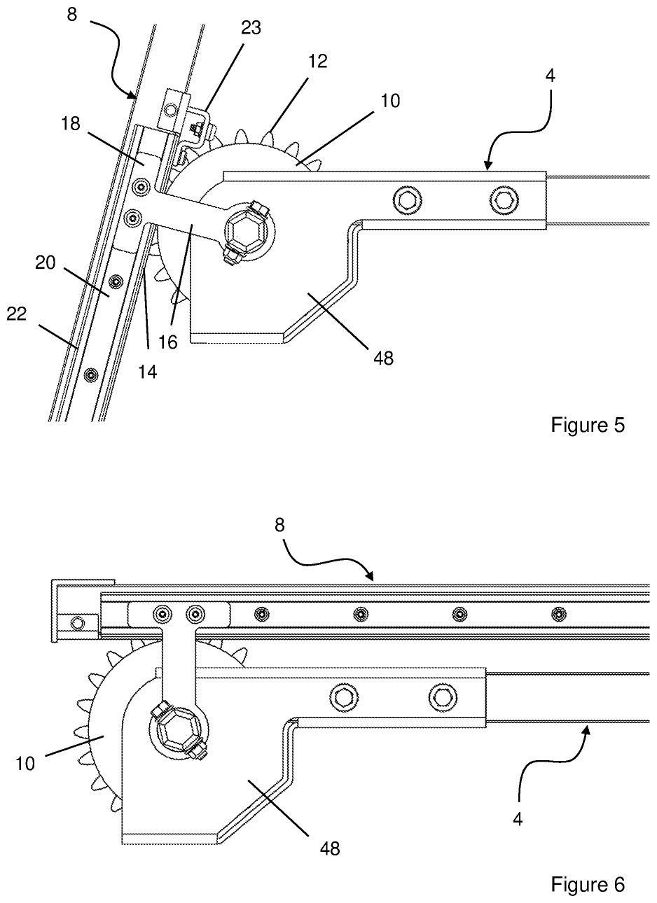

FIG. 5 shows a close up view of an engagement member when the rack system is in a deployed position.

FIG. 6 shows a close up view of an engagement member when the rack system is in a storage position.

FIGS. 1-6 show a vehicle rack system 2 according to an embodiment of the invention.

The rack system 2 is configured to support/secure a load on a vehicle to provide transportation thereof. The present invention is adapted to support one or more ladders. However, it can be appreciated that rack system 2 may be used to support any suitable load, for example, luggage/cases (e.g. hard-shell carriers), bicycles, canoes, kayaks, skis, construction materials (e.g. planks) or the like.

The rack system 2 may be mounted to any suitable vehicle, for example, a van, a car, a pickup, a trailer, a lorry or the like. In this example, the system is adapted to be mounted to the roof of a light commercial vehicle, i.e. a van. Suitable vehicles may have conventional roof mounting points for attachment of roof racks or the like. Corresponding mounting formations may be provided on the rack system 2.

The rack system 2 is actuatable/movable between a storage position (see FIGS. 3 and 4) where the load is in a stowed position, e.g. atop the vehicle, to allow transportation of the load, and a deployed position (see FIGS. 1 and 2) where the load is more accessible to allow access/removal of the load from the vehicle. For example, in the deployed position, the portion of the rack system 2 to which the load is mounted is at a lower position than in the storage position. The deployed position thus presents the load for access by a user or allows easy installation of the load on the rack.

In an embodiment, the rack system 2 is mounted to a roof of a vehicle, such that in the storage position, the load is secured to the roof. In the deployed position, the load may be positioned at side of the vehicle. Such an arrangement prevents the rack system 2 from unintentionally deploying during a front and/or rear impact of the vehicle (e.g. during a crash), and prevents blocking of the rear doors.

In other embodiments, in the deployed position, the load may be positioned at a front/rear of the vehicle or other substantially vertical surfaces of the vehicle.

The rack system 2 comprises a support member 4 configured to affix the rack system to the vehicle. The support member 4 comprises one or more fastening means to releasably/permanently secure the rack system 2 to the vehicle. For example, the support member 4 may be secured to the vehicle doorframe, a fixed mounting point or one or more pre-existing side rails/factory bars, as is conventional.

The support member 4 may comprise a plurality of elongate beams 6. In use, the end of the beams may be attached to a roof rack rail/mounting points, such that the beams 6 extend transversely across the vehicle, i.e. extending in a direction between the opposing sides of the vehicle. The beams 6 are preferably parallel.

The elongate beams define rails or runners, i.e. static members, over which other actuatable components of the rack system can move.

A carriage 8 is attached to the support member 4 and configured to support the load in use. The carriage 8 may comprise attachment features to allow attachment of the load, for example, hooks, holes, eyes, flanges, pins, screws/bolts or the like. A cross member 8A at either or both ends of the carriage could be raised to define a lip or other abutment formation against which the load can be positioned if desired.

The carriage 8 may be substantially frame-like (e.g. an open structure), for example, a rectangular frame. In other embodiments, the carriage 8 may comprise a substantially continuous surface (e.g. a tray like construction) or may comprise an enclosed compartment. For example, the carriage may form part of/be integral with a luggage container.

The carriage 8 may comprise one or more features to enhance the grip/friction between the carriage and the load. The carriage 8 may comprise a high friction material, for example rubber, on an upper surface thereof. Additionally or alternatively, the carriage 8 comprises a plurality of elongate ridges/grooves extending along the axis of the frame.

The carriage 8 is translatable (e.g. movable in a linear direction) and rotatable with respect to the support member, to allow the carriage 8 to move from the storage position to the deployed position.

The support member 4 comprises a rotatable engagement member that engages and supports the carriage 8 as it moves from the storage position to the deployed position. The engagement member engages/supports the movement of the carriage 8 in the translational movement and the rotational movement of the carriage 8. The carriage 8 is configured to move relatively to the engagement member (e.g. such that the carriage 8 moves over the engagement member). The engagement member allows smooth (e.g. a smooth kinematic load) and/or reduced friction movement of the carriage relative to the support member 4.

As shown in closer detail in FIGS. 5 and 6, the engagement member comprises a rotatable wheel 10. The carriage 10 engages the surface of the wheel 10, e.g. on its underside, and thus the wheel 10 rotates as the carriage moves (e.g. rolls or pivots) over the wheel.

The wheel 10 is located at an end of the support member 4, such that the carriage translates and pivots over the end of the support member 4 on the wheel. For example, a plurality of wheels 10 are located at an end of the respective beams 6.

In this example, a pair/plurality of wheels are provided, i.e. one on each support member 4. Each wheel 10 may engage a corresponding elongate member 8B of the carriage frame, e.g. the side members of the frame.

The wheel 10 may comprise one or more engagement features configured to prevent slippage between the carriage 8 and the wheel 10 (e.g. to prevent relative movement between the surface of the carriage 8 and the wheel 10 as the carriage 8 moves thereover). Thus the wheel 10 and carriage 8 move in unison during actuation, e.g. in a 1-to-1 manner.

The engagement features may comprise a plurality of protrusions 12 (e.g. teeth) provided on an outer edge of the of the wheel 10. The wheel thus takes the form of a gear wheel or pinion.

The protrusions 12 engage a plurality of recesses 14 provided on a portion of the carriage 8 engaging the wheel 10 (e.g. on a side facing the wheel 10). The elongate members 8B comprise the recesses 14 in this example.

The recesses 14 are provided in a linear array along the carriage 8, e.g. along a length of the corresponding frame member 8B. The array of recesses may extend along a majority or all of the length of the carriage, i.e. thereby providing engagement along the full length of movement of the carriage 8.

The protrusions 12 on the wheel 10 and the recesses 14 on the carriage act in a manner akin to a ‘rack and pinion’ system.

In this example, the recesses take the form of cavities or openings, e.g. such that the relevant elongate member 8B of the carriage 8 has a series of spaced openings in a ladder-like arrangement. In other examples, the elongate member 8b could be castellated or toothed along its length.

It can be appreciated that in alternative embodiments, the protrusions are provided on the carriage 8 and the recesses/cavities are provided on the wheel 10, or an offset/opposing series of protrusions and recesses could be provided on both the carriage 8 and wheel.

Additionally or alternatively, one or both of the carriage 8 and the wheel 10 comprise a high friction surface to prevent slippage therebetween. For example, one or both of carriage 8 and the wheel 10 may comprise a rubber surface or textured surface to this end.

In some embodiments, the wheel 10 comprises a means to resist/damp rotation thereof, thereby slowing the movement of the carriage 8. For example, the wheel 10 may comprise a brake and/or a frictional bearing. In some embodiments, the moment of inertia of the wheel 10 and/or friction of the rotational bearing may provide the damping.

A retaining member retains the carriage 8 against the wheel 10 (e.g. to prevent disengagement/relative movement between the carriage 8 and the wheel 10). The retaining member may hold the carriage 8 in close contact against the wheel 10, i.e. to prevent/limit movement of the carriage away from the wheel in a radial direction.

The retaining member may comprise an arm 16 extending between the carriage 8 and support member 4. The arm is located proximal the wheel 10 and may be pivotably mounted with a rotational axis thereof. This allows the arm 16 to rotate as the carriage 10 rotates about the wheel 10 during actuation.

The arm may extend in a radial direction relative to the wheel and may span an interface between the wheel 10 and carriage 18.

The arm 16 is movably/slidably attached to the carriage 8 in order to allow the carriage to move relative to the support member 4.

In an embodiment, the arm 16 comprises a head portion 18. The head portion 18 is configured to a engage a groove 20 provided on the carriage 8 to moveably retain the head portion 18 therein. The head portion 18 may be constrained within the groove, or vice versa, so as to permit sliding/linear relative motion therebetween. For example, the groove 20 may comprise a channel/dovetail shape, with the head portion 18 comprising a corresponding profile so as to fit therein. The groove 20 may be provided on a rail like member 22 provided on a side edge of the carriage 8.

The groove 20 and/or rail 22 extends along the carriage 8, thereby allowing the arm 16 to slide along the length of the carriage 8 as required during movement of the carriage 8 relative to the support member 4. For example, as shown in FIG. 4, in the stored position, arm 16 is located at the second end 30 of the carriage. During movement to the deployed position, the arm 16 slides along the rail toward the first end 28 of the carriage 8, as shown in FIG. 1.

The head formation 18 may take the form of a slider block and/or may comprise one or more roller.

The head formation 18 may be elongate in form, i.e. extending a short distance along the groove 20 and/or transversely to the arm (e.g. tangential to the wheel). Accordingly the arm 16 may be T-shaped.

Returning to FIG. 5, one or more stopping member 23 defines the limit of travel of the carriage along the wheel 10 and/or arm 16 in the deployed condition. The stopping member 23 may operatively block the end of the rail 22 or groove 20 thereby preventing the arm 16 from disengaging the groove 20 at the end thereof. Additionally or alternatively, the stopping member 23 may provide an abutment for the wheel 10, e.g. defining the end of the array of recesses 14. The stopping member 23 is removably attached to the carriage 8 and/or rail 23, thereby allowing the arm 16 to disengage rail if required (e.g. during assembly/disassembly of the rack 2).

A second stopping member may be provided towards the other end of the carriage to limit the extent of the translation/rotation of the carriage 8 in the storage position

Turning to FIG. 1, a second retaining member/mechanism 24 limits the extent of the translation/rotation of the carriage 8 in the deployed position.

Additionally or alternatively, the second retaining mechanism 24 defines/controls the angle/position of the carriage 8 relative to the support 4 through the cycle of movement between the deployed/storage position.

The second retaining mechanism comprises an arm 26 extending between the support member 4 and the carriage 8. The carriage 8 comprises a raised flange 38, shown in FIG. 2, e.g. extending above the plane of the carriage 8 and/or proximal a first end 28 thereof. A first end of the arm 26 comprises an end portion 50, which may be angled relative to the arm 26. The end portion 50 is rotatably connected to the flange 38, e.g. at a pivot point. that the angle of the end portion means that the end portion extends above the plane of the carriage 8 as best seen in FIGS. 3 and 4.

A rotatable shaft 32 extends transverse to the beams 6. The shaft 32 is rotatably mounted to a plurality of downwardly extending brackets 52 provided on each of the respective beams 6 and extends therebetween. The shaft 32 is provided in a fixed longitudinal position along the length of the beams 6, e.g. in a middle portion thereof or exactly half way along the length of the beams.

The second end of the arm 26 is fixed to the shaft 32, such that the arm 26 is rotationally mounted to the support member 4 via the shaft 32.

The raised flange 38, downwardly extending bracket 52 and angled end portion 50 allow the arm 26 to be angled upwards toward the first end 28 when in the storage position. This allows the first arm 26 to act a lever to raise the carriage 8 as the carriage is moved towards the second end 30, and ensure the first arm 26 rotates upwardly (rather than rotating downwardly, which would lock the arms 26).

The arm 26 ensures the carriage 4 moves along fixed rotational/translational path, in a arc like motion. Thus, the arm 26 ensures the carriage 8 rotates and moves in smooth fashion relative to the support member 4 and prevents any ‘jolting’.

A damping member 36, for example, a gas spring, extends between the support member 4 and the arm 26, to provide damping of the relative movement between the support 4 and the carriage 8. A first end of the damping member 36 is rotatably mounted to the support member 4 at a central portion/region thereof. The second end of the damping member 36 is rotatably connected to a central portion/region of the arm 26.

In other embodiments, the damping member 36 extends directly between the support member 4 and the carriage 8. For example, the damping member may be connected to the raised flanges 38 on the carriage 8.

The rack system 2 may comprise a plurality of the arms 26 and and/or respective damping members 36. A respective arm 26 and/or damping member 36 may be provided at each side of the rack system (i.e. the arm is connected to the shaft 32 proximal the beams 6). One or more intermediate arms located between the respective arms 26 may be provided, depending on the load requirements.

The rack system 2 comprises an actuator 40 configured to impart a rotation to the wheel 10 and therefore impart movement to the carriage 8. This allows the user to manually actuate the carriage between the deployed/storage positions.

In an embodiment, the actuator 40 comprises a first axle portion 42. The first axle portion 42 is operatively connected to the wheel 10 to impart a rotation about the axis of wheel 10. A removable handle portion 44 is removably attached to the axle portion 42. The handle portion may be substantially ‘S-shaped’ or ‘L-shaped’ to provide leverage to the operator to allow rotation of the axle portion 42. A central portion 44a of the handle portion 44 may be between 1 m and 2 m, preferably 1.5 m, to allow the operator to easily use the handle whilst standing on the ground. The removable handle portion 44 may be stored in the vehicle when not in use.

The first axle portion 42 comprises a shaped end 45 to allow attachment of the handle portion 44 and prevent relative rotation therebetween (e.g. the shaped end is rotational asymmetric). A securing means may be provided to prevent unintentional disconnection of the handle portion 44. The end 45 may comprise an unconventional shape/profile (e.g. a complex/irregular polygon), with the handle portion 44 comprising matching shaped/profile, thereby preventing unauthorised actuation of the handle 40 by a conventional handle.

A second axle portion 46 extends between the plurality of wheels 10 so that the wheels 10 may be rotated in unison. The second axle portion could be an extension of the first axle portion 42.

A rachet device configuration is provided in the drive path between the axle portion 42, 46 and the respective wheel 10, e.g. to allow rotation relative to the wheel 10 in a first direction and prevent relative rotation in a second direction. For example, the rachet device may be provided at an end of the handle portion 44. The ratchet may be reversible such that relative rotation is prevented in the first direction and permitted in the second direction, e.g. to drive actuation of the carriage in the reverse direction.

The ratchet allows the user the to rotate the handle in first a direction (e.g. to move store/deploy the carriage 8) and then rotate the handle in a second direction without affecting movement of the wheel 10. This allows the operator to move the carriage 8 by moving in the handle 44 in a backward and forwards motion (rather than using full rotations of the handle). This also allows the operator to move the carriage 8 in an upward direction incrementally, thereby reducing the strain on the operator.

The rack comprises a switch (e.g. a lever) configured to change the permitted rotation direction of the ratchet device. The handle portion 44 comprises a hook at an end thereof configured to the engage the lever and actuate the switch.

The ratchet arrangement may permit free-wheeling in the driven direction, e.g. to allow the carriage to fall under the weight of the load such that the user only needs to initiate the actuation and does not need to drive the full descent of the carriage. The handle 44 is provided at a side edge of the rack system 2 and distal therefrom, such that the operator is sufficiently removed from the rack system 2 during movement of the carriage 8 and allowing a full view of the area, thereby reducing the risk of injury.

In other embodiments, an electric motor can be installed to drive rotation of the to drive movement of the carriage 8. The motor may be connected to a switch or the like to allow the operator selectively deploy/store the carriage, i.e. to select the driven direction of the motor.

A guard 48 (shown in FIG. 5) encloses a portion of the wheel 10 to prevent contact between the wheel 10 and the operator and/or vehicle. The guard 48 is open an on upper face and a side face such that the wheel 10 extends therethrough to allow engagement with the carriage 8 during movement thereof. Thus only a portion of the wheel 10 (e.g. approximately half the wheel) is exposed.

The ratchet switch may be provided on the guard 48.

Operation of the Invention

Starting in the stored condition, the operator attaches the removable handle portion 44 to the first axle portion 42. The rachet device is set such rotation of the handle 42 moves the carriage 8 toward the deployed position.

The carriage 8 moves over the wheel 10 and is retained against the wheel 10 via the retaining arm 16, the retaining arm head 18 sliding along the groove 20 on the carriage. The arm 26 causes the first end 28 of the carriage to raise upward and the second end 30 of the carriage to tip downward, thus simultaneously rotating the carriage around the wheel 10. Movement is continually damped by the gas springs 36 (e.g. to provide smooth motion of the carriage 8) and the operator may manually support the downwards movement of the carriage 8 as required.

The carriage 8 moves until the arm 26 and/or the gas spring 36 reach a full extent and prevent further movement thereof. The carriage 8 now rests in the deployed position.

The load may be removed from or attached to the carriage as is conventionally performed. One or two ladders, or other load, can be mounted onto the carriage in the deployed condition without requiring the user to lift the ladders above shoulder/head height. If ladders are being mounted, they are arranged longitudinally with respect to the vehicle and/or parallel with cross members 8A of the carriage.

The direction of the ratchet device is now switched for raising the carriage to the stored condition, allowing the user to rachet the handle 42 to impart movement towards the storage position. The operator may manually, or via the handle 42, move the carriage 8 towards the storage position, whilst the ratchet device prevents the carriage 8 moving downwards.

Once in the storage position the ratchet prevents the carriage 8 moving downwards, thereby locking it in place.

Whilst the mechanism has been described herein as being like a rack-and-pinion mechanism, it is bespoke to the current invention in that it permits both rotation and linear actuation of the carriage concurrently. Gas springs are provided in the above examples only to prevent any jolts of the carriage, e.g. towards the end of its movement. The system is far less sensitive to the gas springs being tailored to the weight of the load. Alternative damping mechanisms could be used to this end, if desired.

The control of the pivoting and sliding motion of the carriage is better than in the prior art. This is, at least in part, because it does not require the large initial force to commence displacement of the carriage form the storage condition, as would be required for a four bar linkage. Furthermore, the carriage can be actuated between deployed/stored conditions safely, even if a gas spring were to fail.

1. A vehicle rack system comprising:
a support member affixed to a vehicle in use;
a carriage, for supporting a load, attached to the support member, the carriage both translatable and rotatable relative to the support member between a storage position and a deployed position;
the support member comprising a rotatable engagement member to engage and support the carriage during translation and rotation between the storage position and the deployed position, where one of the carriage and the engagement member comprises a plurality of spaced protrusions and the other of the carriage and the engagement member comprises a series of recesses at corresponding spacing arranged to receive the protrusions;
an axle for driving rotation of the engagement member to cause the carriage to move over the engagement member in unison therewith; and
a ratchet configured to allow rotation of the engagement member in a first direction and prevent rotation in a second direction, where the ratchet is selectively reversible to allow rotation in the second direction and prevent rotation in the first direction.

2. A vehicle rack system according to claim 1, where the carriage comprises first and second ends spaced apart in the direction of translation between the storage and deployed positions, and where the rotation of the engagement member away from the storage position causes rotation of the carriage so as to raise the first end.

3. A vehicle rack system according to claim 2, where the first end is a trailing end and the second end is a leading end during movement from the storage position to the deployed position.

4. A vehicle rack system according to claim 2, where one of the carriage and the support member comprises a catch member spaced from the second end and/or engagement member and arranged to selectively prevent movement of the carriage away from the storage position.

5. A vehicle rack system according to claim 4, where the catch member selectively prevents rotation of the carriage away from the storage position.

6. A vehicle rack system according to claim 5, where catch member selectively prevents rotation of the carriage away from the storage position only when the carriage and support member are laterally offset but permits rotation therebetween when laterally aligned.

7. A vehicle rack system according to claim 4, where the catch member comprises a neck formation and a head formation, the other of the carriage and support member arranged to receive the head formation in the storage position.

8. A vehicle rack system according to claim 1, where a retaining member extends between the carriage and the support member to prevent disengagement of the carriage from the engagement member.

9. A vehicle rack system according to claim 8, where the retaining member is movably mounted to the carriage.

10. A vehicle rack system according to claim 8, where the retaining member is rotatably mounted to the support member.

11. A vehicle rack system according to claim 8, where the retaining member and the engagement member are rotatable about a common axis.

12. A vehicle rack system according to claim 1, where the engagement member is mounted proximal an end of the support member.

13. A vehicle rack system according to claim 1, comprising a handle for rotating the axle for manually rotating the engagement member.

14. A vehicle rack system according to claim 13, where the handle is removably attachable to the axle.

15-16. (canceled)

17. A vehicle rack system according to claim 1, comprising a plurality of engagement members, the engagement members having a common axis of rotation and/or wherein the axle is common the plurality of engagement members.

18. A vehicle rack system according to claim 1, comprising an arm rotatably connected to both the support member and the carriage and extending therebetween, the arm configured to impart a rotation to the carriage relative to the support member.

19. A vehicle rack system according to claim 18, where the arm is connected to the support member via a shaft rotatably connected to the support member.

20. A vehicle rack system according to claim 18, where said arm is connected to a fixed pivot point on the support member and/or carriage.

21. A vehicle rack system according to claim 18, comprising a pair of said arms, each arm being on an opposing side of the support member and/or carriage.

22. A vehicle rack system according to claim 1, comprising one or more damper configurated to damp movement of the carriage relative to the support member.

23. A vehicle rack system according to claim 18, comprising one or more damper configurated to damp movement of the carriage relative to the support member, where the damper is rotatably connected to both the arm and the support member.

24. A vehicle rack system according to claim 1, when in the storage position, the carriage is substantially parallel or co-planar to the support member and, when in the deployed position, the carriage is angled at between 60 and 90 degrees relative to the support member.
